(19) United States
(12) Patent Application Publication
(10) Pub. No.: US 2026/0260945 A1
(43) Pub. Date: Sep. 3, 2026

(54) NON-AQUEOUS ELECTROLYTE, ELECTROCHEMICAL APPARATUS, AND ELECTRONIC APPARATUS

(71) Applicant: Ningde Amperex Technology Limited, Ningde (CN)

(72) Inventors: Jianyu LIU, Ningde (CN); Zhiyi GAO, Ningde (CN); Qi JIANG, Ningde (CN); Chao TANG, Ningde (CN)

(73) Assignee: Ningde Amperex Technology Limited, Ningde (CN)

(21) Appl. No.: 19/554,676

(22) Filed: Mar. 3, 2026

(30) Foreign Application Priority Data
Mar. 3, 2025 (CN) 202510245229.X

(51) Int. Cl. H01M 10/0569; H01M 4/02; H01M 4/131; H01M 4/525; H01M 10/0525; H01M 10/0567; H01M 10/0568

(52) U.S. Cl. CPC H01M 10/0569; H01M 4/131; H01M 4/525; H01M 10/0525; H01M 10/0567; H01M 10/0568; H01M 2004/028; H01M 2300/0034; H01M 2300/0042

(57) ABSTRACT

A non-aqueous electrolyte includes ethylene carbonate, propylene carbonate, propyl propionate, and ethyl propionate. Based on a total mass of the non-aqueous electrolyte, mass percentages of ethylene carbonate, propylene carbonate, propyl propionate, and ethyl propionate are A %, B %, C %, and D % respectively, where 5≤A≤15, 5≤B≤15, 30≤C≤50, 5≤D≤20, A≥B, and 2≤C/D≤3.5.

### CROSS-REFERENCE TO THE RELATED APPLICATION

This application claims the benefit of priority from the Chinese Patent Application No. 202510245229.X, filed on Mar. 3, 2025, the entire content of which is incorporated herein by reference.

### TECHNICAL FIELD

This application relates to the field of energy storage, and specifically, to a non-aqueous electrolyte, an electrochemical apparatus, and an electronic apparatus.

### BACKGROUND

Electrochemical apparatuses such as lithium-ion batteries are widely used in portable electronic products, electric vehicles, aerospace, energy storage, and other fields due to their advantages such as high energy density, good cycling performance, high safety, environmental friendliness, and no memory effect. However, the existing electrochemical apparatuses typically fail to exhibit enhanced cycling performance at room temperature while maintaining their high-temperature performance.

### SUMMARY

This application provides a non-aqueous electrolyte, an electrochemical apparatus, and an electronic apparatus. When the non-aqueous electrolyte of this application is used in an electrochemical apparatus, cycling performance at room temperature of the electrochemical apparatus can be improved while maintaining high-temperature performance of the electrochemical apparatus.

According to a first aspect, this application provides a non-aqueous electrolyte including ethylene carbonate, propylene carbonate, propyl propionate, and ethyl propionate, where based on a total mass of the non-aqueous electrolyte, mass percentages of ethylene carbonate, propylene carbonate, propyl propionate, and ethyl propionate are A %, B %, C %, and D % respectively, 5≤A≤15, 5≤B≤15, 30≤C≤50, 5≤D≤20, A≥B, and 2≤C/D≤3.5.

In the above non-aqueous electrolyte, the inventors have found that when the above non-aqueous electrolyte is used in an electrochemical apparatus, the synergy among the components of the non-aqueous electrolyte can improve the cycling performance of the electrochemical apparatus at room temperature while maintaining the high-temperature performance of the electrochemical apparatus.

In a possible embodiment, the non-aqueous electrolyte further includes fluoroethylene carbonate, where based on a total mass of non-aqueous electrolyte, a mass percentage of fluoroethylene carbonate is E %, and 4≤E≤7.

In the above technical solution, when the non-aqueous electrolyte is used in the electrochemical apparatus, fluoroethylene carbonate in the non-aqueous electrolyte can protect the positive electrode and the negative electrode of the electrochemical apparatus, so that the electrochemical apparatus can exhibit good cycling performance.

In a possible embodiment, the non-aqueous electrolyte further includes 1,3-propane sultone, where based on the total mass of the non-aqueous electrolyte, a mass percentage of 1,3-propane sultone is F %, and 2≤F≤3.5.

In the above technical solution, the 1,3-propane sultone in the non-aqueous electrolyte can protect the positive electrode of the electrochemical apparatus, so that the electrochemical apparatus can exhibit good cycling performance.

In a possible embodiment, the non-aqueous electrolyte further includes succinonitrile, where based on the total mass of the non-aqueous electrolyte, a mass percentage of succinonitrile is G %, and 1≤G≤2.5.

In the above technical solution, adding an appropriate amount of succinonitrile to the non-aqueous electrolyte further facilitates improvement of the cycling performance of the electrochemical apparatus at room temperature.

In a possible embodiment, the non-aqueous electrolyte further includes 1,3,6-hexanetricarbonitrile, where based on the total mass of the non-aqueous electrolyte, a mass percentage of 1,3,6-hexanetricarbonitrile is H %, and 2≤H≤4.5.

In the above technical solution, the introduction of 1,3,6-hexanetricarbonitrile can significantly improve hot-box performance of a battery cell.

In a possible embodiment, the non-aqueous electrolyte further includes adiponitrile, where based on the total mass of the non-aqueous electrolyte, a mass percentage of adiponitrile is I %, and 0.1≤I≤0.5.

In the above technical solution, adding an appropriate amount of adiponitrile to the non-aqueous electrolyte further facilitates improvement of the cycling performance of the electrochemical apparatus at room temperature.

In a possible embodiment, the non-aqueous electrolyte further includes trimethylacetonitrile, where based on the total mass of the non-aqueous electrolyte, a mass percentage of trimethylacetonitrile is J %, and 0.1≤J≤0.5.

In the above technical solution, trimethylacetonitrile in the non-aqueous electrolyte has a lower viscosity, improving kinetic performance of the non-aqueous electrolyte; in addition, trimethylacetonitrile can also improve stability of the positive electrode in the electrochemical apparatus, facilitating improvement of cycling performance of the electrochemical apparatus.

In a possible embodiment, the non-aqueous electrolyte further includes fluoroacetonitrile, where based on the total mass of the non-aqueous electrolyte, a mass percentage of fluoroacetonitrile is K %, and 0.1≤K≤5.

In the above technical solution, the fluoroacetonitrile in the non-aqueous electrolyte has a lower viscosity, improving kinetic performance of the non-aqueous electrolyte; in addition, fluoroacetonitrile can also improve stability of the positive electrode in the electrochemical apparatus, facilitating improvement of the cycling performance of the electrochemical apparatus.

According to a second aspect, this application provides an electrochemical apparatus including a positive electrode, a negative electrode, and the above non-aqueous electrolyte, where the positive electrode includes a positive electrode current collector and a positive electrode active material layer located on at least one surface of the positive electrode current collector; the positive electrode active material layer includes a doping element, where the doping element includes at least one of the titanium element, the magnesium element, the aluminum element, the manganese element, or the nickel element; and based on the total mass of the positive electrode, a mass content of the doping element is M ppm, where 4000≤M≤8500.

In the above electrochemical apparatus, the synergy between the non-aqueous electrolyte of this application and the positive electrode improves the cycling performance at room temperature of the electrochemical apparatus while maintaining the high-temperature performance of the electrochemical apparatus.

In a possible embodiment, the doping element includes manganese element, and based on a total mass of the positive electrode, a mass content of manganese element is N ppm, and 500≤N≤3000.

In the above technical solution, the electrochemical apparatus exhibits better cycling stability and safety performance.

According to a third aspect, this application provides an electronic apparatus including the above electrochemical apparatus. Therefore, the electronic apparatus provided in this application exhibits good performance.

The beneficial effects of this application are as follows:

This application provides a non-aqueous electrolyte, an electrochemical apparatus, and an electronic apparatus. The non-aqueous electrolyte includes ethylene carbonate, propylene carbonate, propyl propionate, and ethyl propionate, where based on a total mass of the non-aqueous electrolyte, mass percentages of ethylene carbonate, propylene carbonate, propyl propionate, and ethyl propionate are A %, B %, C %, and D % respectively, 5≤A≤15, 5≤B≤15, 30≤C≤50, 5≤D≤20, A≥B, and 2≤C/D≤3.5. The components in the non-aqueous electrolyte and the contents of the components are controlled to significantly improve the cycling performance at room temperature of the electrochemical apparatus in this application while maintaining high-temperature performance of the electrochemical apparatus.

### DETAILED DESCRIPTION

To make the objectives, technical solutions, and advantages of some embodiments of this application clearer, the technical solutions in these embodiments of this application are clearly and completely described below. These embodiments that do not indicate specific conditions are carried out according to conventional conditions or conditions recommended by manufacturers. Reagents or instruments that do not indicate manufacturers are conventional products that can be purchased commercially.

A non-aqueous electrolyte, an electrochemical apparatus, and an electronic apparatus in some embodiments of this application are specifically described below.

According to a first aspect, this application provides a non-aqueous electrolyte including ethylene carbonate, propylene carbonate, propyl propionate, and ethyl propionate. Based on a total mass of the non-aqueous electrolyte, mass percentages of ethylene carbonate, propylene carbonate, propyl propionate, and ethyl propionate are A %, B %, C %, and D % respectively, where 5≤A≤15, 5≤B≤15, 30≤C≤50, 5≤D≤20, A≥B, and 2≤C/D≤3.5. Specifically, A may be 5, 8, 10, 12, 15, or the like, or within a range defined by any two of the above values; B may be 5, 7, 9, 13, 15, or the like, or within a range defined by any two of the above values; C may be 30, 32, 38, 40, 45, 50, or the like, or within a range defined by any two of the above values; D may be 5, 8, 10, 13, 18, 20, or the like, or within a range defined by any two of the above values; and C/D may be 2, 2.2, 2.8, 3, 3.5, or the like, or within a range defined by any two of the above values. The non-aqueous electrolyte in this application may be used in an electrochemical apparatus to transport lithium ions and electrons and ensure formation of a path inside the electrochemical apparatus.

The inventors have unexpectedly found that although ethylene carbonate, propylene carbonate, propyl propionate, and ethyl propionate each have their own advantages and disadvantages, when contents of the four are controlled within the ranges in this application for combined use, with the content of ethylene carbonate being greater than that of propylene carbonate and a mass ratio of propyl propionate to ethyl propionate being in the range of 2 to 3.5, the electrochemical apparatus containing the non-aqueous electrolyte can not only maintain its high-temperature performance but also significantly improve its cycling performance at room temperature. Specifically, although ethylene carbonate and propylene carbonate have good capability to dissociate lithium salts, they have relatively high viscosity and poor interfacial stability (especially poorer stability at high temperature). Ethylene carbonate is prone to decomposition on a positive electrode side during operation, but it has a good film-forming effect on a negative electrode; propylene carbonate easily leads to instability of the negative electrode in the electrochemical apparatus, but it has good stability for the positive electrode; and propyl propionate and ethyl propionate have lower conductivity but low viscosity and strong infiltration ability for positive and negative electrode plates. When the four are mixed in a specific ratio, the electrolyte has a good film-forming effect at the positive and negative electrode interfaces under both high temperature and room temperature, which can improve the cycling performance at room temperature of the electrochemical apparatus while maintaining high-temperature performance of the electrochemical apparatus.

In some embodiments of this application, to further improve the cycling performance of the electrochemical apparatus, the non-aqueous electrolyte further includes fluoroethylene carbonate or 1,3-propane sultone, and based on a total mass of the non-aqueous electrolyte, mass percentages of fluoroethylene carbonate and 1,3-propane sultone are E % and F % respectively, where 4≤E≤7 and 2≤F≤3.5. Appropriate contents of fluoroethylene carbonate and 1,3-propane sultone can both protect the positive electrode and/or negative electrode of the electrochemical apparatus, so that the electrochemical apparatus can exhibit good cycling performance. Specifically, E may be 4, 4.5, 5, 6, 6.5, 7, or the like, or within a range defined by any two of the above values; F may be 2, 2.2, 2.8, 3, 3.2, 3.5, or the like, or within a range defined by any two of the above values.

In some embodiments of this application, based on the mass of the non-aqueous electrolyte, the non-aqueous electrolyte may further include a nitrile compound with a specific content, such as at least one of G % succinonitrile, H % 1,3,6-hexanetricarbonitrile, I % adiponitrile, or J % trimethylacetonitrile, where 1≤G≤2.5, 2≤H≤4.5, 0.1≤I≤0.5, and 0.1≤J≤0.5. Succinonitrile, adiponitrile, and trimethylacetonitrile of specific contents help further improve the room-temperature cycling performance of the electrochemical apparatus, and 1,3,6-hexanetricarbonitrile of a specific content can improve hot-box performance.

In addition, in some embodiments of this application, the non-aqueous electrolyte may further include fluoroacetonitrile, where based on a total mass of the non-aqueous electrolyte, a mass percentage of fluoroacetonitrile is K %, where 0.1≤K≤5; specifically, K may be 0.1, 1, 1.5, 2.4, 3.2, 3.8, 4.5, 5, or the like, or within a range defined by any two of the above values. Fluoroacetonitrile can improve the stability of the positive electrode in the electrochemical apparatus, helping improve the cycling performance of the electrochemical apparatus.

According to a second aspect, this application further provides an electrochemical apparatus including a positive electrode, a negative electrode, and the non-aqueous electrolyte according to this application; and besides the non-aqueous electrolyte, structures of various parts of the electrochemical apparatus of this application are as follows.

### Positive Electrode

The positive electrode (also referred to as “positive electrode plate”) includes a positive electrode current collector and a positive electrode active material layer provided on at least one surface of the positive electrode current collector. That is, in this application, the positive electrode active material layer may be provided on one surface in a thickness direction of the positive electrode current collector or on two surfaces in the thickness direction of the positive electrode current collector. Moreover, in this application, “surface of the positive electrode current collector” may be the entire area of the positive electrode current collector or a partial area of the positive electrode current collector. This is not particularly limited in this application as long as the objective of this application can be achieved.

The positive electrode active material layer of this application includes a doping element. The doping element may be at least one of the titanium element, the magnesium element, the aluminum element, the manganese element, or the nickel element. Based on a total mass of the positive electrode, a mass content of the doping element is M ppm, where 4000≤M≤8500. Preferably, the positive electrode generally contains the manganese element, and, based on the total mass of the positive electrode, the mass content of the manganese element is N ppm, where 500≤N≤3000.

The inventors have found that in existing electrochemical apparatuses, when the positive electrode contains the above doping element, although the high-temperature performance is improved, the problem that the cycling performance at room temperature cannot be balanced is particularly obvious; therefore, adding the non-aqueous electrolyte in this application into the above electrochemical apparatus can better solve the problem that the cycling performance at room temperature and the high-temperature performance of the electrochemical apparatus having a positive electrode with a doping element cannot be balanced.

Components of the positive electrode active material layer include a positive electrode active substance, and the positive electrode active substance may be any substance capable of reversibly intercalating and deintercalating alkali metal ions such as Li⁺ and Na⁺ to ensure normal charge and discharge of the electrochemical apparatus, and the doping element is generally provided by the positive electrode active substance. For example, the positive electrode active substance includes but is not limited to at least one of lithium iron phosphate (LiFePO₄), lithium cobalt oxide (LiCoO2), lithium manganese oxide, lithium nickel oxide, or ternary material. The ternary material includes but is not limited to at least one of LiNiₓCo_{y}Mn_{z}O₂, LiNiₓCo_{y}Al_{z}O₂, or the like. Contents of Ni, Co, Mn, Al, or the like can be adjusted as long as x+y+z=1. For example, the ternary material may be LiNi_{0.6}Co_{0.2}Mn_{0.2}O₂, LiNi_{0.88}Co_{0.08}Mn_{0.04}O₂, LiNi_{0.8}Co_{0.15}Mn_{0.05}O₂, LiNi_{0.8}Co_{0.1}Mn_{0.1}O₂, LiNi_{0.88}Co_{0.1}Mn_{0.02}O₂, LiNi_{0.8}Co_{0.15}Al_{0.05}O₂, LiNi_{0.88}Co_{0.1}Al_{0.02}O₂, or the like.

In some embodiments, the components of the positive electrode active material layer further include a positive electrode conductive agent. A type of the positive electrode conductive agent is not particularly limited in this application, and any known conductive material may be used. Specifically, the positive electrode conductive agent includes but is not limited to at least one of carbon black such as acetylene black and Super-P, materials such as amorphous carbon like needle coke, carbon nanotubes, or graphene.

In some embodiments, the components of the positive electrode active material layer generally further contain a positive electrode binder. A type of the positive electrode binder used in the manufacture of the positive electrode active material layer is not particularly limited. In the case where a coating method is used, any material that can be dissolved or dispersed in a liquid medium used in electrode manufacture may be used. The positive electrode binder includes but is not limited to one or at least two of the following: resin-based polymers such as polyethylene, polypropylene, polyethylene terephthalate, polymethyl methacrylate, polyimide, aromatic polyamide, cellulose, and nitrocellulose; rubbery polymers such as styrene-butadiene rubber (SBR), nitrile-butadiene rubber (NBR), fluororubber, isoprene rubber, polybutadiene rubber, and ethylene-propylene rubber; thermoplastic elastomer-like polymers such as styrene-butadiene-styrene block copolymer or its hydrogenated product, ethylene-propylene-diene terpolymer (EPDM), styrene-ethylene-butadiene-ethylene copolymer, and styrene-isoprene-styrene block copolymer or its hydrogenated product; soft resin-like polymers such as syndiotactic-1,2-polybutadiene, polyvinyl acetate, ethylene-vinyl acetate copolymer, and propylene-α-olefin copolymer; fluorinated polymers such as polyvinylidene fluoride (PVDF), polytetrafluoroethylene, fluorinated polyvinylidene fluoride, and polytetrafluoroethylene-ethylene copolymer; and polymer compositions having ionic conductivity of alkali metal ions (especially lithium ions).

In the positive electrode, a type of the positive electrode current collector is not particularly limited, and may be any known material suitable for use as a positive electrode current collector. A material of the positive electrode current collector includes but is not limited to metal materials such as aluminum, stainless steel, nickel plating, titanium, and tantalum. In addition, to reduce an electronic contact resistance between the positive electrode current collector and the positive electrode active material layer, a conductive aid, a conductive coating layer, or the like may be provided on the surface of the positive electrode current collector. The conductive aid includes but is not limited to carbon and noble metals such as gold, platinum, and silver. The conductive coating layer may be a mixture layer of inorganic oxide, conductive agent, and positive electrode binder.

In preparation of the positive electrode, the components in the above positive electrode active material layer may be dissolved or dispersed in a liquid solvent to prepare a positive electrode slurry, and then the positive electrode slurry is applied to the positive electrode current collector and dried, thereby forming a positive electrode active material layer on the positive electrode current collector. In this case, a positive electrode can be obtained. In preparation of the positive electrode in this manner, the solvent in the positive electrode slurry is not particularly limited as long as it can dissolve or disperse the above components. Specifically, the solvent in the positive electrode slurry includes but is not limited to N-methylpyrrolidone (NMP), ethylene carbonate (EC), or the like. In addition, in preparation of the positive electrode, the components in the positive electrode active material layer may be dry-mixed to form a sheet, and then the obtained sheet is pressure-bonded to the positive electrode current collector.

### Negative Electrode

The negative electrode (also referred to as “negative electrode plate”) includes a negative electrode current collector and a negative electrode active material layer provided on at least one surface of the negative electrode current collector, and the components of the negative electrode active material layer include a negative electrode active substance. That is, in this application, the negative electrode active material layer may be provided on one surface in a thickness direction of the negative electrode current collector or on two surfaces in the thickness direction of the negative electrode current collector. Moreover, in this application, “surface of the negative electrode current collector” may be the entire area of the negative electrode current collector or a partial area of the negative electrode current collector. This is not particularly limited in this application as long as the objective of this application can be achieved.

The negative electrode active material layer generally contains a negative electrode active material. The negative electrode active material is not particularly limited in this application. Specifically, the negative electrode active material may include at least one of a carbon material or a silicon-based material. More specifically, the carbon material includes but is not limited to at least one of natural graphite, artificial graphite, mesocarbon microbeads, hard carbon, or soft carbon; and the silicon-based material includes but is not limited to at least one of silicon, silicon-oxygen composite material, or silicon-carbon composite material.

In some embodiments, the negative electrode active material layer generally further contains a negative electrode conductive agent. A type of the negative electrode conductive agent is not particularly limited in this application as long as the objective of this application can be achieved. For example, the negative electrode conductive agent includes but is not limited to at least one of acetylene black, Ketjen black, carbon nanotubes, carbon fibers, carbon dots, or graphene.

In some embodiments, the negative electrode active material layer may also contain a negative electrode binder and a thickener. Types of the negative electrode binder and the thickener are not particularly limited in this application as long as the objective of this application can be achieved. For example, the negative electrode binder may include but is not limited to at least one of polyvinyl alcohol, polyvinyl chloride, carboxylated polyvinyl chloride, polyvinyl fluoride, polyvinylpyrrolidone, polyurethane, polytetrafluoroethylene, polyvinylidene fluoride, styrene-butadiene rubber, or acrylated styrene-butadiene rubber; and the thickener in the negative electrode slurry may include but is not limited to at least one of sodium carboxymethyl cellulose or lithium carboxymethyl cellulose.

In the negative electrode, the material of the negative electrode current collector includes but is not limited to copper foil, nickel foil, stainless steel foil, titanium foil, foamed nickel, foamed copper, or a polymer substrate coated with a conductive metal. This is not particularly limited in this application. The conductive metal includes but is not limited to copper, nickel, or titanium, and a material of the polymer substrate includes but is not limited to at least one of polyethylene, polypropylene, ethylene-propylene copolymer, polyethylene terephthalate, polyethylene naphthalate, or poly(p-phenylene terephthalamide).

In addition, in this application, thicknesses of the negative electrode current collector and the negative electrode active material layer are not particularly limited as long as the objective of this application can be achieved. For example, the thickness of the negative electrode current collector is 4 μm to 12 μm, and the thickness of one negative electrode active material layer is 30 μm to 160 μm.

In addition, similar to the preparation of the positive electrode, in preparation of the negative electrode, a negative electrode slurry may be prepared, and then the negative electrode slurry is applied to the negative electrode current collector and dried, thereby forming a negative electrode active material layer on the negative electrode current collector to obtain a negative electrode; alternatively, the components in the negative electrode active material layer may be dry-mixed to form a sheet, and then the obtained sheet is pressure-bonded to the negative electrode current collector to form a negative electrode active material layer. In this way, a negative electrode is obtained. The solvent in the negative electrode slurry includes any one of an aqueous solvent or an organic solvent. The aqueous solvent includes but is not limited to water, a mixed solvent of alcohol and water, or the like. The organic solvent includes but is not limited to aliphatic hydrocarbons such as hexane; aromatic hydrocarbons such as benzene, toluene, xylene, and methylnaphthalene; heterocyclic compounds such as quinoline and pyridine; ketones such as acetone, methyl ethyl ketone, and cyclohexanone; esters such as methyl acetate and methyl acrylate; amines such as diethylene triamine and N,N-dimethylaminopropylamine; ethers such as diethyl ether, propylene oxide, and tetrahydrofuran (THF); amides such as N-methylpyrrolidone (NMP), dimethylformamide, and dimethylacetamide; and aprotic polar solvents such as hexamethylphosphoramide and dimethyl sulfoxide. In addition, in some other embodiments, when an aqueous solvent is used, the components of the negative electrode slurry further include a thickener and a styrene-butadiene rubber (SBR) emulsion to slurry the negative electrode slurry, thereby adjusting a viscosity of the negative electrode slurry. Types of the thickener in the positive electrode slurry include but are not limited to at least one of carboxymethyl cellulose, methyl cellulose, hydroxymethyl cellulose, ethyl cellulose, polyvinyl alcohol, oxidized starch, phosphorylated starch, casein, and salts thereof.

### Separator

To prevent short circuit, a separator is usually provided between the positive electrode and the negative electrode. In this case, the non-aqueous electrolyte in this application is usually used for infiltrating the separator.

A material and a shape of the separator are not particularly limited as long as the effect of this application is not significantly impaired. The material of the separator may be resin, glass fiber, inorganic substance, or the like formed of a material stable to the electrolyte of this application. In some embodiments, the separator includes a porous sheet, non-woven fabric-like substance, or the like excellent in electrolyte retention. Examples of the material of the resin or glass fiber separator include but are not limited to polyolefins, aromatic polyamides, polyimides (PI), polyamides (PA), polytetrafluoroethylene, polyethersulfone, spandex, or aramid. In some embodiments, the polyolefin is polyethylene or polypropylene. In some embodiments, the polyolefin is polypropylene. The above separator materials may be used alone or in any combination.

The separator may alternatively be a material obtained by stacking the above materials, and examples thereof include, but are not limited to, a three-layer separator or the like obtained by sequentially stacking polypropylene, polyethylene, and polypropylene.

A material of the inorganic substance includes but is not limited to oxides such as alumina and silica, nitrides such as aluminum nitride and silicon nitride, and sulfates (for example, barium sulfate and calcium sulfate). A form of the inorganic substance includes but is not limited to a granular or fibrous form.

A form of the separator may be a film form, including but not limited to non-woven fabric, woven fabric, microporous film, or the like. For the film form, a pore size of the separator is 0.01 μm to 1 μm, and a thickness is 5 μm to 50 μm. In addition to the above independent film-like separator, the following separator may also be used: a separator formed by forming a composite porous layer containing the above inorganic substance particles on the surface of the positive electrode and/or negative electrode using a resin-based binder, for example, a separator formed by forming a porous layer containing alumina particles with 90% particle size less than 1 μm on two sides of the positive electrode using a fluororesin as a binder.

A thickness of the separator is arbitrary. In some embodiments, the thickness of the separator is greater than 1 μm, greater than 5 μm, or greater than 8 μm. In some embodiments, the thickness of the separator is less than 50 μm, less than 40 μm, or less than 30 μm. When the thickness of the separator is within the above range, insulation and mechanical strength can be ensured, and the rate characteristic and energy density of the electrochemical apparatus can be ensured.

In this application, the separator may include a substrate and a surface treatment layer. The substrate may be a non-woven fabric or a composite film having a porous structure, and the material of the substrate may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, a surface treatment layer is provided on at least one surface of the substrate, and the surface treatment layer may be a polymer layer or an inorganic substance layer, or a layer formed by mixing a polymer and an inorganic substance. For example, the inorganic substance layer includes an inorganic particle and a binder, and the above inorganic particle is not particularly limited in this application, for example, it may include at least one of alumina, silica, magnesia, titania, hafnia, tin oxide, ceria, nickel oxide, zinc oxide, calcium oxide, zirconia, yttria, silicon carbide, boehmite, aluminum hydroxide, magnesium hydroxide, calcium hydroxide, or barium sulfate. The above binder is not particularly limited in this application in this application, for example, it may be at least one of the aforementioned binders. The polymer layer contains a polymer, and a material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

The electrochemical apparatus in this application further includes a packaging bag for accommodating the positive electrode, the separator, the negative electrode, and the electrolyte, as well as other components in the electrochemical apparatus known in the art, and the above other components are not limited in this application. The packaging bag is not particularly limited in this application, and it may be any packaging bag known in the art as long as the objective of this application can be achieved.

Moreover, it should be noted that in the subsequent specific embodiments of this application, a lithium-ion secondary battery is taken as an example of the electrochemical apparatus to explain this application, but the electrochemical apparatus in this application is not limited to a lithium-ion secondary battery. For example, the electrochemical apparatus of this application may include but is not limited to: a lithium metal secondary battery, a lithium polymer secondary battery, or a lithium-ion polymer secondary battery (lithium-ion polymer battery), or the like.

According to a third aspect, this application further provides an electronic apparatus including the electrochemical apparatus according to this application.

The use of the electrochemical apparatus in this application is not specifically limited, and it may be used in any electronic apparatus known in the prior art. In some embodiments, the electrochemical apparatus of this application may be used for, but not limited to, notebook computers, pen-input computers, mobile computers, e-book players, portable telephones, portable fax machines, portable copiers, portable printers, stereo headphones, video recorders, liquid crystal displays, portable cleaners, portable CD players, mini discs, transceivers, electronic notebooks, calculators, memory cards, portable recorders, radios, backup power supplies, motors, automobiles, motorcycles, power-assisted bicycles, bicycles, lighting fixtures, toys, game consoles, clocks, electric tools, flashlights, cameras, large household batteries, lithium-ion capacitors, and the like.

### EXAMPLES

Hereinafter, a lithium-ion secondary battery is taken as an example, and examples and comparative examples are given to more specifically explain some embodiments of the electrochemical apparatus in this application. Those skilled in the art should understand that the preparation methods described in this application are only examples, and any other suitable preparation methods are within the scope of this application.

### Test Methods and Devices:

Test for cycling performance at high-temperature (45° C.)

The cycling performance of the lithium-ion battery was evaluated based on a capacity retention rate after 400 cycles at 45° C. A higher capacity retention rate after 400 cycles at 45° C. indicated better cycling performance of the lithium-ion battery.

The lithium-ion battery was placed in a 45° C. constant temperature chamber and left standing for 30 minutes to bring the lithium-ion battery to a constant temperature. The lithium-ion battery that reached the constant temperature was charged at 45° C. with a constant current of 0.2 C to 4.5V, charged at a constant voltage of 4.5V to 0.05 C, left standing for 5 minutes, then discharged at a constant current of 0.2 C to 3.0V, and left standing for 5 minutes. An initial discharge capacity C₀ of the lithium-ion battery was tested. Then the battery was charged at a constant current of 1.8 C to 4.15V, charged at a constant voltage of 4.15V to the current of 1 C, then charged at a constant current of 1 C to 4.25V, then charged at a constant voltage of 4.25V to the current of 0.8 C, then charged at a constant current of 0.8 C to 4.5V, then charged at a constant voltage of 4.5V to the current of 0.05 C, left standing for 5 minutes, then discharged at a constant current of 1 C to 3.0V, and left standing for 5 minutes. This was one charge/discharge cycle. The charge/discharge cycle steps were performed for 400 cycles, and a discharge capacity C₁ of the lithium-ion battery after 400 cycles was measured.

Herein, capacity retention rate after 400 cycles at 45° C.=C₁/C₀×100%. A higher capacity retention rate after 400 cycles at 45° C. indicated better high-temperature cycling performance of the lithium-ion battery. The specific data of the high-temperature cycling performance in the lithium-ion batteries of the examples and comparative examples are shown in “400 cycles capacity retention rate at 45° C. (%)” in Tables 1 to 5.

### Test for Cycling Performance at Room Temperature (25° C.)

The cycling performance of the lithium-ion battery was evaluated based on a capacity retention rate after 400 cycles at 25° C. A higher capacity retention rate after 400 cycles at 25° C. indicated better cycling performance of the lithium-ion battery.

The lithium-ion battery was placed in a 25° C. constant temperature chamber and left standing for 30 minutes to bring the lithium-ion battery to a constant temperature. The lithium-ion battery that reached the constant temperature was charged at 25° C. with a constant current of 0.2 C to 4.5V, charged at a constant voltage of 4.5V to 0.05 C, left standing for 5 minutes, then discharged at a constant current of 0.2 C to 3.0V, and left standing for 5 minutes. An initial discharge capacity C₀ of the lithium-ion battery was tested. Then the battery was charged at a constant current of 1.8 C to 4.15V, charged at a constant voltage of 4.15V to a current of 1 C, then charged at a constant current of 1 C to 4.25V, then charged at a constant voltage of 4.25V to a current of 0.8 C, then charged at a constant current of 0.8 C to 4.5V, then charged at a constant voltage of 4.5V to a current of 0.05 C, left standing for 5 minutes, then discharged at a constant current of 1 C to 3.0V, and left standing for 5 minutes. This was one charge/discharge cycle. The above charge/discharge cycle steps were performed for 400 cycles, and a discharge capacity C₁ of the lithium-ion battery after 400 cycles was measured.

Herein, capacity retention rate after 400 cycles at 25° C.=C₁/C₀×100%. A higher capacity retention rate after 400 cycles at 25° C. indicated better high-temperature cycling performance of the lithium-ion battery. The specific data of the high-temperature cycling performance in the lithium-ion batteries of the examples and comparative examples are shown in “400 cycles capacity retention rate at 25° C. (%)” in Tables 1 to 5.

### Hot-Box Test

At 25° C., the lithium-ion battery was charged at a constant current of 0.7 C to 4.5V and charged at a constant voltage of 4.5V to the current of 0.05 C. The battery was placed in a high-temperature chamber, heated to 135° C. at a temperature rise rate of 5±2° C./min, and then held for 1 hour. Changes in the voltage and temperature of the battery and hot-box temperature were recorded. Whether the lithium-ion battery caught fire was observed. If the lithium-ion battery did not catch fire, the lithium-ion battery passed the hot-box test. Ten batteries were tested in each example and comparative example, and results were recorded. The specific results are shown in “Hot-box test result at 135° C.” in Tables 1 to 5.

### Example 1-1

### <Preparation of Electrolyte>

In an argon atmosphere glove box with a water content less than 10 ppm, diethyl carbonate and ethyl acetate were mixed in a mass ratio of 1:1 to prepare a base solvent, and then lithium salt lithium hexafluorophosphate (LiPF₆), ethylene carbonate, propylene carbonate, propyl propionate, and ethyl propionate were added to form an electrolyte. Based on a total mass of the electrolyte, a mass percentage of LiPF₆ was 12.5%. Mass percentages of ethylene carbonate, propylene carbonate, propyl propionate, and ethyl propionate are shown in Table 1. The balance was the base solvent.

### <Preparation of Positive Electrode>

Lithium cobalt oxide, conductive agent conductive carbon black, and polyvinylidene fluoride (PVDF) were mixed in a mass ratio of 95:2:3, with N-methylpyrrolidone (NMP) added; and were uniformly stirred by a vacuum mixer to obtain a positive electrode slurry with a solid content of 70 wt %. The positive electrode slurry was uniformly applied to upper and lower surfaces of a positive electrode current collector aluminum foil with a thickness of 9 μm, which was dried, pressed, and cut into a predetermined size to obtain a positive electrode.

### <Preparation of Negative Electrode>

Artificial graphite, styrene-butadiene rubber (SBR), polyacrylic acid (PAA), carbon nanotubes (CNT), and carboxymethyl cellulose (CMC) were mixed in a mass ratio of 95.8:2.4:0.5:0.5:0.8, with deionized water added as a solvent; and then stirred uniformly to prepare a negative electrode slurry with a solid content of 45 wt %. The negative electrode slurry was uniformly applied to upper and lower surfaces of a negative electrode current collector copper foil with a thickness of 6 μm, which was dried, pressed, and cut into a predetermined size to obtain a negative electrode.

### <Separator>

A porous polyethylene film with a thickness of 15 μm was used as the separator.

### <Preparation of Electrochemical Apparatus>

The positive electrode, separator, negative electrode, and separator prepared above were stacked in order with the separator positioned between the positive electrode and the negative electrode for isolation, and then wound to obtain an electrode assembly. After welding tabs, the electrode assembly was placed in an aluminum-plastic film packaging bag, dried in a vacuum oven at 85° C. for 12 hours to remove moisture. The prepared electrolyte was injected. After vacuum sealing, standing, formation, shaping, and capacity testing, a lithium-ion battery was obtained.

### Examples 1-2 to 1-20

These examples were the same as Example 1-1 except that the relevant preparation parameters were adjusted according to Table 1.

### Example 1-21

This example was the same as Example 1-11 except that the positive electrode was prepared in the following manner.

### <Preparation of Positive Electrode>

Lithium cobalt oxide doped with the titanium element, conductive agent conductive carbon black, and polyvinylidene fluoride (PVDF) were mixed in a mass ratio of 95:2:3, with N-methylpyrrolidone (NMP) added. The resulting mixture was uniformly stirred by a vacuum mixer to obtain a positive electrode slurry with a solid content of 70 wt %. The positive electrode slurry was uniformly applied to upper and lower surfaces of a positive electrode current collector aluminum foil with a thickness of 9 μm, which was dried, pressed, and cut into a predetermined size to obtain a positive electrode. In the obtained positive electrode, based on a total mass of the positive electrode, a content of the titanium element was 6000 ppm.

### Examples 1-22 to 1-33

These examples were the same as Example 1-21 except that the relevant preparation parameters of the positive electrode were adjusted according to Table 1.

### Comparative Examples 1 to 15

These comparative examples were the same as Example 1-1 except that the relevant preparation parameters of the electrolyte were adjusted according to Table 1.

TABLE 1

| | Electrolyte components | | | | | Positive | Capacity | Capacity | |
|---|---|---|---|---|---|---|---|---|---|
| | Ethylene | Propylene | Propyl | Ethyl | | electrode | retention | retention | |
| | carbonate | carbonate | propionate | propionate | | doping | rate after | rate after | Hot-box |
| | percentage | percentage | percentage | percentage | | element | 400 cls at | 400 cls at | test result |
| Group | A (%) | B (%) | C (%) | D (%) | C/D | and content | 25° C. (%) | 45° C. (%) | at 135° C. |
| Example 1-1 | 5 | 5 | 36 | 12 | 3 | None | 86 | 70 | 7/10 pass |
| Example 1-2 | 8 | 7 | 36 | 12 | 3 | None | 86.5 | 70 | 6/10 pass |
| Example 1-3 | 10 | 7 | 36 | 12 | 3 | None | 87 | 69.5 | 5/10 pass |
| Example 1-4 | 12 | 7 | 36 | 12 | 3 | None | 87 | 69.5 | 3/10 pass |
| Example 1-5 | 15 | 7 | 36 | 12 | 3 | None | 87.5 | 69 | 0/10 pass |
| Example 1-6 | 13 | 5 | 36 | 12 | 3 | None | 87 | 69 | 4/10 pass |
| Example 1-7 | 13 | 7 | 36 | 12 | 3 | None | 87 | 69.5 | 5/10 pass |
| Example 1-8 | 13 | 9 | 36 | 12 | 3 | None | 86.5 | 69.5 | 5/10 pass |
| Example 1-9 | 13 | 13 | 36 | 12 | 3 | None | 86 | 69.5 | 7/10 pass |
| Example 1-10 | 15 | 15 | 36 | 12 | 3 | None | 85 | 70 | 8/10 pass |
| Example 1-11 | 13 | 7 | 30 | 12 | 2.5 | None | 87 | 69 | 5/10 pass |
| Example 1-12 | 13 | 7 | 35 | 12 | 2.92 | None | 87 | 69 | 5/10 pass |
| Example 1-13 | 13 | 7 | 38 | 12 | 3.17 | None | 87 | 69 | 5/10 pass |
| Example 1-14 | 13 | 7 | 40 | 12 | 3.33 | None | 87.5 | 69.5 | 7/10 pass |
| Example 1-15 | 13 | 7 | 45 | 13 | 3.46 | None | 88 | 69.5 | 7/10 pass |
| Example 1-16 | 13 | 7 | 50 | 15 | 3.33 | None | 87.5 | 69 | 7/10 pass |
| Example 1-17 | 13 | 7 | 30 | 9 | 3.33 | None | 87 | 69 | 6/10 pass |
| Example 1-18 | 13 | 7 | 35 | 10 | 3.5 | None | 87 | 69 | 6/10 pass |
| Example 1-19 | 13 | 7 | 36 | 18 | 2 | None | 86.5 | 68.5 | 4/10 pass |
| Example 1-20 | 13 | 7 | 40 | 20 | 2 | None | 86 | 68.5 | 5/10 pass |
| Example 1-21 | 13 | 7 | 30 | 12 | 2.5 | 6000 ppm | 85 | 72 | 7/10 pass |
| | | | | | | titanium | | | |
| Example 1-22 | 13 | 7 | 30 | 12 | 2.5 | 6000 ppm | 85 | 71.5 | 7/10 pass |
| | | | | | | magnesium | | | |
| Example 1-23 | 13 | 7 | 30 | 12 | 2.5 | 6000 ppm | 85.5 | 72.5 | 10/10 pass |
| | | | | | | aluminum | | | |
| Example 1-24 | 13 | 7 | 30 | 12 | 2.5 | 6000 ppm | 84.5 | 70 | 7/10 pass |
| | | | | | | nickel | | | |
| Example 1-25 | 13 | 7 | 30 | 12 | 2.5 | 4000 ppm | 85.5 | 71 | 7/10 pass |
| | | | | | | titanium | | | |
| Example 1-26 | 13 | 7 | 30 | 12 | 2.5 | 5000 ppm | 85.5 | 71.5 | 7/10 pass |
| | | | | | | titanium | | | |
| Example 1-27 | 13 | 7 | 30 | 12 | 2.5 | 7000 ppm | 84.5 | 73 | 7/10 pass |
| | | | | | | titanium | | | |
| Example 1-28 | 13 | 7 | 30 | 12 | 2.5 | 8500 ppm | 84 | 75 | 7/10 pass |
| | | | | | | titanium | | | |
| Example 1-29 | 13 | 7 | 30 | 12 | 2.5 | 500 ppm | 85.5 | 71 | 7/10 pass |
| | | | | | | manganese + | | | |
| | | | | | | 3500 ppm | | | |
| | | | | | | titanium | | | |
| Example 1-30 | 13 | 7 | 30 | 12 | 2.5 | 800 ppm | 85.5 | 71.5 | 7/10 pass |
| | | | | | | manganese + | | | |
| | | | | | | 3500 ppm | | | |
| | | | | | | titanium | | | |
| Example 1-31 | 13 | 7 | 30 | 12 | 2.5 | 1800 ppm | 85.5 | 72 | 7/10 pass |
| | | | | | | manganese + | | | |
| | | | | | | 3500 ppm | | | |
| | | | | | | titanium | | | |
| Example 1-32 | 13 | 7 | 30 | 12 | 2.5 | 2500 ppm | 85 | 73 | 7/10 pass |
| | | | | | | manganese + | | | |
| | | | | | | 3500 ppm | | | |
| | | | | | | titanium | | | |
| Example 1-33 | 13 | 7 | 30 | 12 | 2.5 | 3000 ppm | 84.5 | 74.5 | 7/10 pass |
| | | | | | | manganese + | | | |
| | | | | | | 3500 ppm | | | |
| | | | | | | titanium | | | |
| Comparative | 13 | 7 | 30 | 8 | 3.75 | None | 78 | 65 | 5/10 pass |
| example 1 | | | | | | | | | |
| Comparative | 13 | 7 | 36 | 20 | 1.8 | None | 74 | 63 | 3/10 pass |
| example 2 | | | | | | | | | |
| Comparative | 5 | 7 | 36 | 12 | 3 | None | 80 | 64 | 7/10 pass |
| example 3 | | | | | | | | | |
| Comparative | 3 | 5 | 36 | 12 | 3 | None | 78 | 64 | 7/10 pass |
| example 4 | | | | | | | | | |
| Comparative | 16 | 7 | 36 | 12 | 3 | None | 80 | 60 | 0/10 pass |
| example 5 | | | | | | | | | |
| Comparative | 13 | 4 | 36 | 12 | 3 | None | 78 | 60 | 2/10 pass |
| example 6 | | | | | | | | | |
| Comparative | 15 | 18 | 36 | 12 | 3 | None | 74 | 63 | 8/10 pass |
| example 7 | | | | | | | | | |
| Comparative | 13 | 7 | 28 | 12 | 2.33 | None | 79 | 64 | 7/10 pass |
| example 8 | | | | | | | | | |
| Comparative | 13 | 7 | 52 | 15 | 3.47 | None | 77 | 62 | 7/10 pass |
| example 9 | | | | | | | | | |
| Comparative | 13 | 7 | 30 | 4 | 7.5 | None | 80 | 65 | 7/10 pass |
| example 10 | | | | | | | | | |
| Comparative | 13 | 7 | 45 | 22 | 2.05 | None | 76 | 63 | 3/10 pass |
| example 11 | | | | | | | | | |
| Comparative | 13 | 7 | 30 (methyl | 12 | — | None | 70 | 60 | 0/10 pass |
| example 12 | | | propionate | | | | | | |
| | | | instead) | | | | | | |
| Comparative | 13 | 7 | 30 | 12 (methyl | — | None | 70 | 63 | 5/10 pass |
| example 13 | | | | propionate | | | | | |
| | | | | instead) | | | | | |
| Comparative | None | 7 | 30 | 12 | 2.5 | None | 71 | 65 | 8/10 pass |
| example 14 | | | | | | | | | |
| Comparative | 13 | None | 30 | 12 | 2.5 | None | 79 | 62 | 0/10 pass |
| example 15 | | | | | | | | | |

### Example 2-1

This example was the same as Example 1-11 except that 1,3,6-hexanetricarbonitrile was further added in <preparation of electrolyte> and the relevant preparation parameters were adjusted according to Table 2. When the mass percentage of 1,3,6-hexanetricarbonitrile changed, the content of LiPF₆ remained unchanged.

### Examples 2-2 to 2-8

These examples were the same as Example 2-1 except that the relevant preparation parameters were adjusted according to Table 2.

TABLE 2

| | Electrolyte components | | | | | Capacity | Capacity | |
|---|---|---|---|---|---|---|---|---|
| | Ethylene | Propylene | Propyl | Ethyl | 1,3,6- | retention | retention | |
| | carbonate | carbonate | propionate | propionate | hexanetricarbonitrile | rate after | rate after | Hot-box |
| | percentage | percentage | percentage | percentage | percentage | 400 cls at | 400 cls at | test result |
| Group | A (%) | B (%) | C (%) | D (%) | H (%) | 25° C. (%) | 45° C. (%) | at 135° C. |
| Example | 13 | 7 | 30 | 12 | 0 | 87 | 69 | 5/10 pass |
| 1-11 | | | | | | | | |
| Example | 13 | 7 | 30 | 12 | 2 | 88 | 73 | 8/10 pass |
| 2-1 | | | | | | | | |
| Example | 13 | 7 | 30 | 12 | 2.4 | 88 | 73 | 9/10 pass |
| 2-2 | | | | | | | | |
| Example | 13 | 7 | 30 | 12 | 2.8 | 87.5 | 74 | 10/10 pass |
| 2-3 | | | | | | | | |
| Example | 13 | 7 | 30 | 12 | 3 | 87.5 | 74.5 | 10/10 pass |
| 2-4 | | | | | | | | |
| Example | 13 | 7 | 30 | 12 | 3.4 | 87 | 74 | 10/10 pass |
| 2-5 | | | | | | | | |
| Example | 13 | 7 | 30 | 12 | 3.6 | 87 | 74 | 10/10 pass |
| 2-6 | | | | | | | | |
| Example | 13 | 7 | 30 | 12 | 4 | 86 | 74 | 10/10 pass |
| 2-7 | | | | | | | | |
| Example | 13 | 7 | 30 | 12 | 4.5 | 85.5 | 74 | 10/10 pass |
| 2-8 | | | | | | | | |

### Example 3-1

This example was the same as Example 1-11 except that fluoroethylene carbonate was further added in <preparation of electrolyte> and the relevant preparation parameters were adjusted according to Table 3. When the mass percentage of fluoroethylene carbonate changed, the content of LiPF₆ remained unchanged.

### Examples 3-2 to 3-6

These examples were the same as Example 3-1 except that the relevant preparation parameters were adjusted according to Table 3.

TABLE 3

| | Electrolyte components | | | | | Capacity | Capacity | |
|---|---|---|---|---|---|---|---|---|
| | Ethylene | Propylene | Propyl | Ethyl | Fluoroethylene | retention | retention | |
| | carbonate | carbonate | propionate | propionate | carbonate | rate after | rate after | Hot-box |
| | percentage | percentage | percentage | percentage | percentage | 400 cls at | 400 cls at | test result |
| Group | A (%) | B (%) | C (%) | D (%) | E (%) | 25° C. (%) | 45° C. (%) | at 135° C. |
| Example 1-11 | 13 | 7 | 30 | 12 | 0 | 87 | 69 | 5/10 pass |
| Example 3-1 | 13 | 7 | 30 | 12 | 4 | 92 | 71 | 5/10 pass |
| Example 3-2 | 13 | 7 | 30 | 12 | 4.5 | 92.5 | 71 | 5/10 pass |
| Example 3-3 | 13 | 7 | 30 | 12 | 5 | 92.5 | 71 | 5/10 pass |
| Example 3-4 | 13 | 7 | 30 | 12 | 5.5 | 93 | 71 | 4/10 pass |
| Example 3-5 | 13 | 7 | 30 | 12 | 6 | 93 | 70.5 | 3/10 pass |
| Example 3-6 | 13 | 7 | 30 | 12 | 7 | 93.5 | 70.5 | 3/10 pass |

### Example 4-1

This example was the same as Example 1-11 except that a nitrile compound was further added in <preparation of electrolyte> and the relevant preparation parameters were adjusted according to Table 4. When the mass percentage of the nitrile compound changed, the content of LiPF₆ remained unchanged.

### Examples 4-2 to 4-18

These examples were the same as Example 4-1 except that the relevant preparation parameters were adjusted according to Table 4.

TABLE 4

| | Electrolyte components | | | | | Capacity | Capacity | |
|---|---|---|---|---|---|---|---|---|
| | Ethylene | Propylene | Propyl | Ethyl | Type and | retention | retention | Hot-box |
| | carbonate | carbonate | propionate | propionate | percentage of | rate after | rate after | test |
| | percentage | percentage | percentage | percentage | nitrile compound | 400 cls at | 400 cls at | result at |
| Group | A (%) | B (%) | C (%) | D (%) | (%) | 25° C. (%) | 45° C. (%) | 135° C. |
| Example 1-11 | 13 | 7 | 30 | 12 | 0 | 87 | 69 | 5/10 pass |
| Example 4-1 | 13 | 7 | 30 | 12 | 2 | 90 | 71 | 5/10 pass |
| | | | | | (succinonitrile) | | | |
| Example 4-2 | 13 | 7 | 30 | 12 | 2.4 | 90 | 71 | 5/10 pass |
| | | | | | (succinonitrile) | | | |
| Example 4-3 | 13 | 7 | 30 | 12 | 2.8 | 90.5 | 71.5 | 5/10 pass |
| | | | | | (succinonitrile) | | | |
| Example 4-4 | 13 | 7 | 30 | 12 | 3 | 90.5 | 71.5 | 5/10 pass |
| | | | | | (succinonitrile) | | | |
| Example 4-5 | 13 | 7 | 30 | 12 | 3.4 | 91 | 71.5 | 5/10 pass |
| | | | | | (succinonitrile) | | | |
| Example 4-6 | 13 | 7 | 30 | 12 | 3.6 | 91 | 71.5 | 5/10 pass |
| | | | | | (succinonitrile) | | | |
| Example 4-7 | 13 | 7 | 30 | 12 | 4 | 90.5 | 71.5 | 5/10 pass |
| | | | | | (succinonitrile) | | | |
| Example 4-8 | 13 | 7 | 30 | 12 | 4.5 | 90.5 | 71.5 | 6/10 pass |
| | | | | | (succinonitrile) | | | |
| Example 4-9 | 13 | 7 | 30 | 12 | 0.1 | 89 | 70 | 5/10 pass |
| | | | | | (adiponitrile) | | | |
| Example 4-10 | 13 | 7 | 30 | 12 | 0.2 | 89 | 70 | 5/10 pass |
| | | | | | (adiponitrile) | | | |
| Example 4-11 | 13 | 7 | 30 | 12 | 0.3 | 89 | 70 | 5/10 pass |
| | | | | | (adiponitrile) | | | |
| Example 4-12 | 13 | 7 | 30 | 12 | 0.4 | 89.5 | 70 | 5/10 pass |
| | | | | | (adiponitrile) | | | |
| Example 4-13 | 13 | 7 | 30 | 12 | 0.5 | 90 | 70 | 5/10 pass |
| | | | | | (adiponitrile) | | | |
| Example 4-14 | 13 | 7 | 30 | 12 | 0.1 | 89 | 70 | 5/10 pass |
| | | | | | (trimethylacetonitrile) | | | |
| Example 4-15 | 13 | 7 | 30 | 12 | 0.2 | 89 | 70 | 5/10 pass |
| | | | | | (trimethylacetonitrile) | | | |
| Example 4-16 | 13 | 7 | 30 | 12 | 0.3 | 89 | 70 | 5/10 pass |
| | | | | | (trimethylacetonitrile) | | | |
| Example 4-17 | 13 | 7 | 30 | 12 | 0.4 | 89.5 | 70 | 5/10 pass |
| | | | | | (trimethylacetonitrile) | | | |
| Example 4-18 | 13 | 7 | 30 | 12 | 0.5 | 90 | 70 | 5/10 pass |
| | | | | | (trimethylacetonitrile) | | | |

### Example 5-1

This example was the same as Example 1-11 except that fluoroacetonitrile was further added in <preparation of electrolyte> and the relevant preparation parameters were adjusted according to Table 5. When the mass percentage of fluoroacetonitrile changed, the content of LiPF₆ remained unchanged.

### Examples 5-2 to 5-7

These examples were the same as Example 5-1 except that the relevant preparation parameters of the positive electrode were adjusted according to Table 5.

TABLE 5

| | Electrolyte components | | | | | Capacity | Capacity | |
|---|---|---|---|---|---|---|---|---|
| | Ethylene | Propylene | Propyl | Ethyl | | retention | retention | |
| | carbonate | carbonate | propionate | propionate | Fluoroacetonitrile | rate after | rate after | Hot-box |
| | percentage | percentage | percentage | percentage | percentage | 400 cls at | 400 cls at | test result |
| Group | A (%) | B (%) | C (%) | D (%) | K (%) | 25° C. (%) | 45° C. (%) | at 135° C. |
| Example 1-11 | 13 | 7 | 30 | 12 | 0 | 87 | 69 | 5/10 pass |
| Example 5-1 | 13 | 7 | 30 | 12 | 0.1 | 89 | 70 | 5/10 pass |
| Example 5-2 | 13 | 7 | 30 | 12 | 0.8 | 90 | 71 | 5/10 pass |
| Example 5-3 | 13 | 7 | 30 | 12 | 1 | 90 | 71 | 5/10 pass |
| Example 5-4 | 13 | 7 | 30 | 12 | 2 | 90.5 | 71 | 5/10 pass |
| Example 5-5 | 13 | 7 | 30 | 12 | 3 | 91 | 71 | 5/10 pass |
| Example 5-6 | 13 | 7 | 30 | 12 | 4 | 91.5 | 71.5 | 5/10 pass |
| Example 5-7 | 13 | 7 | 30 | 12 | 5 | 92 | 72 | 5/10 pass |

As can be learned from Table 1, when the non-aqueous electrolyte in this application is used in the electrochemical apparatus, the cycling performance at room temperature of the electrochemical apparatus can be improved while maintaining the high-temperature performance of the electrochemical apparatus; moreover, when the positive electrode active material layer contains 4000 ppm to 8500 ppm of the doping element, the synergy between the doping element and the non-aqueous electrolyte improves the high-temperature cycling performance of the electrochemical apparatus while the cycling performance at room temperature is basically not affected.

As can be learned from Table 2, when 2% to 4.5% of 1,3,6-hexanetricarbonitrile is added to the non-aqueous electrolyte, the hot-box performance of the electrochemical apparatus is significantly improved.

As can be learned from Table 3, when 4% to 7% of fluoroethylene carbonate is added to the non-aqueous electrolyte, the cycling performance at room temperature of the electrochemical apparatus is significantly improved.

As can be learned from Table 4, when a nitrile compound of a specific type and mass is added to the non-aqueous electrolyte, the cycling performance at room temperature of the electrochemical apparatus is significantly improved.

As can be learned from Table 5, when 0.1% to 5% of fluoroacetonitrile is added to the non-aqueous electrolyte, the cycling performance at room temperature of the electrochemical apparatus is significantly improved.

The above descriptions are only embodiments of this application and are not intended to limit the protection scope of this application. For those skilled in the art, various modifications and changes may be made to this application. Any modification, equivalent replacement, improvement, and the like made within the spirit and principle of this application shall be included in the protection scope of this application.

What is claimed is:

1. A non-aqueous electrolyte, comprising ethylene carbonate, propylene carbonate, propyl propionate, and ethyl propionate; wherein based on a total mass of the non-aqueous electrolyte, a mass percentage of the ethylene carbonate is A %, a mass percentage of the propylene carbonate is B %, a mass percentage of the propyl propionate is C %, and a mass percentage of the ethyl propionate is D %; wherein 5≤A≤15, 5≤B≤15, 30≤C≤50, 5≤D≤20, A≥B, and 2≤C/D≤3.5.

2. The non-aqueous electrolyte according to claim 1, wherein the non-aqueous electrolyte further comprises fluoroethylene carbonate; based on the total mass of the non-aqueous electrolyte, a mass percentage of the fluoroethylene carbonate is E %, and 4≤E≤7.

3. The non-aqueous electrolyte according to claim 1, wherein the non-aqueous electrolyte further comprises 1,3-propane sultone; based on the total mass of the non-aqueous electrolyte, a mass percentage of the 1,3-propane sultone is F %, and 2≤F≤3.5.

4. The non-aqueous electrolyte according to claim 1, wherein the non-aqueous electrolyte further comprises succinonitrile; based on the total mass of the non-aqueous electrolyte, a mass percentage of the succinonitrile is G %, and 1≤G≤2.5.

5. The non-aqueous electrolyte according to claim 1, wherein the non-aqueous electrolyte further comprises 1,3,6-hexanetricarbonitrile; based on the total mass of the non-aqueous electrolyte, a mass percentage of the 1,3,6-hexanetricarbonitrile is H %, and 2≤H≤4.5.

6. The non-aqueous electrolyte according to claim 1, wherein the non-aqueous electrolyte further comprises adiponitrile; based on the total mass of the non-aqueous electrolyte, a mass percentage of the adiponitrile is I %, and 0.1≤I≤0.5.

7. The non-aqueous electrolyte according to claim 1, wherein the non-aqueous electrolyte further comprises trimethylacetonitrile; based on the total mass of the non-aqueous electrolyte, a mass percentage of the trimethylacetonitrile is J %, and 0.1≤J≤0.5.

8. The non-aqueous electrolyte according to claim 1, wherein the non-aqueous electrolyte further comprises fluoroacetonitrile; based on the total mass of the non-aqueous electrolyte, a mass percentage of the fluoroacetonitrile is K %, and 0.1≤K≤5.

9. An electrochemical apparatus, comprising a positive electrode, a negative electrode, and a non-aqueous electrolyte; wherein the non-aqueous electrolyte comprises ethylene carbonate, propylene carbonate, propyl propionate, and ethyl propionate; wherein based on a total mass of the non-aqueous electrolyte, a mass percentage of the ethylene carbonate is A %, a mass percentage of the propylene carbonate is B %, a mass percentage of the propyl propionate is C %, and a mass percentage of the ethyl propionate is D %; wherein 5≤A≤15, 5≤B≤15, 30≤C≤50, 5≤D≤20, A≥B, and 2≤C/D≤3.5.

10. The electrochemical apparatus according to claim 9, wherein the non-aqueous electrolyte further comprises fluoroethylene carbonate; based on the total mass of the non-aqueous electrolyte, a mass percentage of the fluoroethylene carbonate is E %, and 4≤E≤7.

11. The electrochemical apparatus according to claim 9, wherein the non-aqueous electrolyte further comprises 1,3-propane sultone; based on the total mass of the non-aqueous electrolyte, a mass percentage of the 1,3-propane sultone is F %, and 2≤F≤3.5.

12. The electrochemical apparatus according to claim 9, wherein the non-aqueous electrolyte further comprises succinonitrile; based on the total mass of the non-aqueous electrolyte, a mass percentage of the succinonitrile is G %, and 1≤G≤2.5.

13. The electrochemical apparatus according to claim 9, wherein the non-aqueous electrolyte further comprises 1,3,6-hexanetricarbonitrile; based on the total mass of the non-aqueous electrolyte, a mass percentage of the 1,3,6-hexanetricarbonitrile is H %, and 2≤H≤4.5.

14. The electrochemical apparatus according to claim 9, wherein the non-aqueous electrolyte further comprises adiponitrile; based on the total mass of the non-aqueous electrolyte, a mass percentage of the adiponitrile is I %, and 0.1≤I≤0.5.

15. The electrochemical apparatus according to claim 9, wherein the non-aqueous electrolyte further comprises trimethylacetonitrile; based on the total mass of the non-aqueous electrolyte, a mass percentage of the trimethylacetonitrile is J %, and 0.1≤J≤0.5.

16. The electrochemical apparatus according to claim 9, wherein the non-aqueous electrolyte further comprises fluoroacetonitrile; based on the total mass of the non-aqueous electrolyte, a mass percentage of the fluoroacetonitrile is K %, and 0.1≤K≤5.

17. The electrochemical apparatus according to claim 9, wherein the positive electrode comprises a positive electrode current collector and a positive electrode active material layer located on at least one surface of the positive electrode current collector; the positive electrode active material layer comprises a doping element; wherein the doping element comprises at least one of the titanium element, the magnesium element, the aluminum element, the manganese element, or the nickel element; and based on a total mass of the positive electrode, a mass content of the doping element is M ppm, and 4000≤M≤8500.

18. The electrochemical apparatus according to claim 17, wherein the doping element comprises the manganese element; and based on the total mass of the positive electrode, a mass content of the manganese element is N ppm, and 500≤N≤3000.

19. An electronic apparatus, comprising an electrochemical apparatus, the electrochemical apparatus comprises a positive electrode, a negative electrode, and a non-aqueous electrolyte; wherein the non-aqueous electrolyte comprises ethylene carbonate, propylene carbonate, propyl propionate, and ethyl propionate; wherein based on a total mass of the non-aqueous electrolyte, a mass percentage of the ethylene carbonate is A %, a mass percentage of the propylene carbonate is B %, a mass percentage of the propyl propionate is C %, and a mass percentage of the ethyl propionate is D %; wherein 5≤A≤15, 5≤B≤15, 30≤C≤50, 5≤D≤20, A≥B, and 2≤C/D≤3.5.

20. The electronic apparatus according to claim 19, wherein the positive electrode comprises a positive electrode current collector and a positive electrode active material layer located on at least one surface of the positive electrode current collector; the positive electrode active material layer comprises a doping element; wherein the doping element comprises at least one of the titanium element, the magnesium element, the aluminum element, the manganese element, or the nickel element; and based on a total mass of the positive electrode, a mass content of the doping element is M ppm, and 4000≤M≤8500.
